(19) United States
(12) Patent Application Publication
(10) Pub. No.: US 2026/0317465 A1
(43) Pub. Date: Oct. 15, 2026

(54) COMPOSITION IN POWDER FORM BASED ON A FLUORINATED POLYMER OR A HYDROPHILIC POLYMER

(71) Applicant: Arkema France, Puteaux (FR)

(72) Inventors: Francois BEAUME, Pierre Benite Cedex (FR); Hiu Woon LAI, King of Prussia, PA (US)

(21) Appl. No.: 19/480,866

(22) PCT Filed: May 2, 2024
(86) PCT No.: PCT/FR2024/050568

§ 371 Date: Nov. 3, 2025

(30) Foreign Application Priority Data
May 3, 2023 (FR) 23.04441

(51) Int. Cl. C08F 214/22; C08F 214/28; H01M 4/62; H01M 10/0525

(52) U.S. Cl. CPC C08F 214/22; C08F 214/28; H01M 4/623; H01M 10/0525

(57) ABSTRACT

The present invention relates to a composition in powder form, comprising a polymer P1 comprising monomer units derived from a monomer M0 which is vinylidene fluoride or monomer units derived from a monomer M2 of formula R¹R²C═C(R³)C(O)R in which the substituents R¹, R² and R³ are, independently of each other, selected from the group consisting of H and C₁-C₅ alkyl; R is selected from the group consisting of —NHC(CH₃)₂CH₂C(O)CH₃ or —OR′ with R′ selected from the group consisting of H and C₁-C₁₈ alkyl optionally substituted with one or more —OH groups or a five- or six-membered heterocycle comprising at least one nitrogen atom in its ring chain; or a mixture of said monomer units M0 or M2; characterized in that said polymer P1 has a particle size distribution Dv99 less than 89 μm and a size distribution Dv10 greater than 2.0 μm.

### TECHNICAL FIELD

The present invention relates generally to the field of electrical energy storage in rechargeable secondary batteries of the Li-ion type. More specifically, the invention relates to a composition that can be used as a separator coating.

### TECHNOLOGICAL BACKGROUND OF THE INVENTION

The market for separators for electrochemical devices is dominated by the use of polyolefins (for example Celgard® or Hipore®) produced by extrusion and/or drawing using dry or wet processes. Separators must simultaneously have low thicknesses, an optimum affinity for the electrolyte and a satisfactory mechanical strength and temperature resistance. Among the most advantageous alternatives to polyolefins, polymers which have better affinity toward standard electrolytes have been proposed, in order to reduce the internal resistances of the system, such as poly(methyl methacrylate) (PMMA), poly(vinylidene fluoride) (PVDF) and poly(vinylidene fluoride-hexafluoropropene) (P(VDF-co-HFP)). Another option consists in depositing a coating on one or two faces of the polyolefin separator. The main evaluation criteria for a separator coating are: dry adhesion, wet adhesion, ion conductivity and heat stability.

The dry adhesion is measured after assembly, by pressing or lamination, of the coated separator with an electrode. This adhesion increases with the temperature and the pressure applied after coating. However, it is desirable to use gentle pressing/lamination conditions: a reduced pressure to avoid/limit the closure of the pores and thus to minimize the impact on the ion conductivity, and a moderate temperature to limit the energy consumption and maintain a high line speed/productivity.

The wet adhesion of the coating on the separator is measured after impregnation with the electrolyte. This adhesion decreases when the coating is softened by the electrolyte solvents, leading to swelling of the polymer present in the coating, possibly even the dissolution of the coating. The percentage of swelling or even dissolution or the loss of integrity are used as a first indication of the wet adhesion performance.

The ion conductivity represents the migration of the Li ions through the separator and its coating by virtue of the porosity. In coating via the aqueous route, this porosity corresponds to the interstices between the solid particles which make up the coating: polymer particles (from the latex or from a powder redispersed in water) and/or ceramic particles. In coating via the solvent route, this porosity is created by the phase inversion (exposure of the acetone-based coating to moisture, for example) required prior to or during drying; without phase inversion, simple evaporation of the solvent forms a continuous nonporous coating. The Gurley air permeability is used as a first indication of ion conduction. Beyond the air permeability of the initial coated separator, other aspects may affect the ion conductivity: interaction with the electrolyte (favorable when a slight swelling of the polymer makes it possible to improve wettability/affinity for the electrolyte, unfavorable when excessive swelling of the polymer leads to a reduction in size/clogging of the pores), the effect of the pressing or lamination (reduces the size of/clogs the pores).

The heat stability is low for polyolefin separators alone (made of PE or PP or PP/PE/PP multilayer), which show significant temperature shrinkage. The thermal stability can be markedly improved by a coating containing inorganic particles.

Poly(vinylidene fluoride) (PVDF) and derivatives thereof are advantageous as main constituent material of the separator and also as polyolefin separator coating, for their electrochemical stability and for their high dielectric constant, which promotes the ion dissociation and thus conductivity. The crystallinity of P(VDF-co-HFP) copolymer (copolymer of vinylidene fluoride (VDF) and hexafluoropropylene (HFP)) is lower than that of PVDF. For this reason, the advantage of these P(VDF-co-HFP) copolymers is that they promote conductivity. There is still a need to develop novel coatings for separators that are easy to use and have a good compromise between dry adhesion, wet adhesion and ion conductivity.

The aim of the invention is thus to overcome at least one of the drawbacks of the prior art, namely to propose a polymeric coating for a separator which is able to prevent the swelling or dissolution in an electrolyte solvent/electrolyte solvents while retaining good adhesion properties and a good ion conductivity.

### SUMMARY OF THE INVENTION

According to a first aspect, the present invention relates to a composition, preferably in powder form, comprising a polymer P1 comprising monomer units derived from a monomer M0 which is vinylidene fluoride or monomer units derived from a monomer M2 of formula R¹R²C═C(R³)C(O)R in which the substituents R¹, R² and R³ are, independently of each other, selected from the group consisting of H and C₁-C₅ alkyl; R is selected from the group consisting of —NHC(CH₃)₂CH₂C(O)CH₃ or —OR′ with R′ selected from the group consisting of H and C₁-C₁₈ alkyl optionally substituted with one or more —OH groups or a five- or six-membered heterocycle comprising at least one nitrogen atom in its ring chain; or a mixture of said monomer units M0 or M2; characterized in that said polymer P1 has a particle size distribution Dv99 less than or equal to 89 μm and a particle size distribution Dv10 greater than or equal to 2.0 μm.

The Dv99 is the particle size at the 99th percentile (by volume) of the cumulative particle size distribution. This parameter can be determined by laser particle size analysis. The Dv10 is the particle size at the 10th percentile (by volume) of the cumulative particle size distribution. This parameter can be determined by laser particle size analysis. The particle size distribution is measured using a Microtrac S3500 particle size analyzer, using water as the dispersion medium or measured dry.

It has been observed that the particle size plays an important role in obtaining good adhesion, permeability, or conductivity properties. Said polymer P1 according to the present invention has a particle size distribution specifically selected to improve at least one of the above properties. Specifically, when the polymer particles are too large with a low basis weight, the coverage of the separator is too low to achieve the desired properties. If the particles are too small, the transfer of ions within the separator is insufficient. In addition, if the particle size distribution is too heterogeneous, the adhesion properties are reduced. By specifically choosing particles of said polymer P1 with a size distribution as mentioned in the present patent application, separator coatings comprising the composition according to the present invention have shown a good compromise between the different compositions targeted.

According to a preferred embodiment, said polymer P1 is a homopolymer of vinylidene fluoride or a copolymer comprising monomer units derived from vinylidene fluoride and monomer units derived from a monomer M1 selected from the group consisting of vinyl fluoride, tetrafluoroethylene, hexafluoropropylene, trifluoropropenes, tetrafluoropropenes, hexafluoroisobutylene, perfluorobutylethylene, pentafluoropropenes, perfluoroalkylvinyl ethers, bromotrifluoroethylene, chlorofluoroethylene, chlorotrifluoroethylene, and chlorotrifluoropropene, or a mixture thereof; or a copolymer comprising monomer units derived from vinylidene fluoride and monomer units derived from a monomer M2 as defined in the present patent application.

According to a preferred embodiment, said polymer P1 has a particle size distribution Dv90 of less than or equal to 50 μm, preferably less than or equal to 46 μm.

According to a preferred embodiment, said monomer M1 is hexafluoropropylene.

According to a preferred embodiment, the mass content of said monomer M1 in said polymer P1 is between 0.5% and 20% based on the total weight of said polymer P1, or the mass content of said monomer M2 in said polymer P1 is between 0.01% and 10% based on the total weight of said polymer P1.

According to a preferred embodiment, the melt viscosity of said polymer P1 is greater than or equal to 10 kP at 230° C. and at a shear rate of 100 s⁻¹ measured according to the standard ASTM D3835.

According to a preferred embodiment, said polymer P1 also comprises a functional group selected from the group consisting of carboxylic acid, carboxylic acid anhydride, carboxylic acid esters, epoxy, amide, hydroxyl, carbonyl, mercapto, sulfide, oxazoline, phenolic, ester, ether, siloxane, sulfonic, sulfuric, phosphoric, or phosphonic; preferably carboxylic acid, carboxylic acid anhydride, carboxylic acid esters, hydroxyl, phosphoric, and phosphonic.

According to a preferred embodiment, said polymer P1 has a particle size distribution Dv99 of less than or equal to 89 μm and a particle size distribution Dv10 of greater than or equal to 2.9 μm.

According to a preferred embodiment, said polymer P1 contains monomer units derived from a monomer M2 selected from the group consisting of acrylic acid, methyl acrylate, ethyl acrylate, propyl acrylate, n-butyl acrylate, isobutyl acrylate, t-butyl acrylate, n-dodecyl acrylate, amyl acrylate, isoamyl acrylate, hexyl acrylate, 2-ethylhexyl acrylate, diacetone acrylamide, lauryl acrylate, n-octyl acrylate, hydroxypropyl methacrylate, hydroxybutyl acrylate, methyl acrylic acid, methyl methacrylate, ethyl methacrylate, propyl methacrylate, n-butyl methacrylate, isobutyl methacrylate, t-butyl methacrylate, n-dodecyl methacrylate, amyl methacrylate, isoamyl methacrylate, hexyl methacrylate, 2-ethylhexyl methacrylate, lauryl methacrylate, n-octyl methacrylate, ureido methacrylate and mixtures thereof.

According to a preferred embodiment, said polymer P1 is free of fluoro surfactants.

According to another aspect, the present invention provides a separator comprising said composition according to the present invention.

According to a preferred embodiment, said separator comprises a porous support and said composition according to the present invention; said composition being deposited onto one of the faces of the porous support.

According to another aspect, the present invention provides an Li-ion secondary battery comprising an anode, a cathode and a separator, in which said separator is according to the present invention.

According to another aspect, the present invention provides a binder for an Li-ion battery, comprising the composition according to the present invention.

According to another aspect, the present invention provides an electrode for a lithium-ion battery including a metal collector, at least one face of which is coated with a substrate layer containing an active substance and a binder, characterized in that said binder is according to the present invention.

According to another aspect, the present invention provides an Li-ion secondary battery comprising an anode, a cathode and a separator, in which the anode or the cathode is an electrode according to the present invention.

### DETAILED DESCRIPTION OF THE PRESENT INVENTION

According to a first aspect, the present invention provides a composition in powder form comprising a polymer P1.

### Polymer P1

Said polymer P1 may comprise monomer units derived from a monomer M0 which is vinylidene fluoride. Said polymer P1 may comprise monomer units resulting from a monomer M2 of formula R¹R²C═C(R³)C(O)R in which the substituents R¹, R² and R³ are selected, independently of each other, from the group consisting of H and C₁-C₅ alkyl; R is selected from the group consisting of —NHC(CH₃)₂CH₂C(O)CH₃ or —OR′ with R′ selected from the group consisting of H and C₁-C₁₈ alkyl optionally substituted with one or more —OH groups or a 5- or 6-membered heterocycle comprising at least one nitrogen atom in its ring chain. Said polymer P1 may comprise a mixture of said monomer units M0 and M2.

Said heterocycle can be saturated or unsaturated or aromatic. Said heterocycle can be monocyclic or bicyclic. Said heterocycle can be a pyrrole, pyrrolidine, pyridine, piperidine, pyrimidine, pyrazine, 1,4-dihydropyridine, indole, oxindole, isatin, quinoline, isoquinoline, quinazoline, imidazoline, pyrazolidine, 2-pyrrolidone, δ-lactam, succinimide, 2-imidazolidinone or 4-imidazolidinone ring. Said heterocycle can be substituted with one or more C₁-C₅ alkyl groups. As mentioned above, the C₁-C₁₈ alkyl is optionally substituted with said heterocycle. The latter can be bonded to the alkyl chain via the nitrogen atom or any other atom forming the heterocycle. Preferably, the heterocycle is 2-pyrrolidone, δ-lactam, succinimide, 2-imidazolidinone or 4-imidazolidinone.

Said monomer M2 may be of formula R¹R²C═C(R³)C(O)R in which the substituents R¹, R² and R³ are selected, independently of each other, from the group consisting of H and C₁-C₅ alkyl; R is selected from the group consisting of —NHC(CH₃)CH₂C(O)CH₃ or —OR′ with R′ selected from the group consisting of H and C₁-C₁₈ alkyl optionally substituted with one or more —OH groups or a 5- or 10-membered heterocycle comprising at least one nitrogen atom in its ring chain. Preferably, the heterocycle is as defined above; in particular, the heterocycle is 2-pyrrolidone, δ-lactam, succinimide, 2-imidazolidinone or 4-imidazolidinone. Preferably, the substituent R′ is selected from the group consisting of H, methyl, ethyl, propyl, n-butyl, isobutyl, t-butyl, n-dodecyl, amyl, isoamyl, hexyl, 2-ethylhexyl, lauryl, n-octyl, hydroxyethyl, hydroxybutyl, hydroxypropyl and ethyl, substituted with a ureido group. In particular, said monomer M2 is of formula R¹R²C═C(R³)C(O)R in which the substituents R¹ and R² are H; R³ is H or CH₃; R is —OR′ with R′ selected from the group consisting of H, methyl, ethyl, propyl, n-butyl, isobutyl, t-butyl, hydroxypropyl, hydroxybutyl, 2-pyrrolidone, deltalactam, succinimide, 2-imidazolidinone and 4-imidazolidinone.

More particularly, said monomer M2 may be acrylic acid, methyl acrylate, ethyl acrylate, propyl acrylate, n-butyl acrylate, isobutyl acrylate, t-butyl acrylate, n-dodecyl acrylate, amyl acrylate, isoamyl acrylate, hexyl acrylate, 2-ethylhexyl acrylate, diacetone acrylamide, lauryl acrylate, n-octyl acrylate, hydroxypropyl methacrylate, hydroxybutyl acrylate, methyl acrylic acid, methyl methacrylate, ethyl methacrylate, propyl methacrylate, n-butyl methacrylate, isobutyl methacrylate, t-butyl methacrylate, n-dodecyl methacrylate, amyl methacrylate, isoamyl methacrylate, hexyl methacrylate, 2-ethylhexyl methacrylate, lauryl methacrylate, n-octyl methacrylate, ureido methacrylate and the mixtures thereof. Among these, said monomer M2 with an alkyl group containing from 1 to 8 carbon atoms is preferred, and an alkyl group containing from 1 to 5 carbon atoms is more preferable. Said polymer P1 may comprise one or more monomer units derived from said monomer M2 as defined herein.

Said polymer P1 may comprise monomer units derived from a monomer M1 that is copolymerizable with vinylidene fluoride.

The comonomers compatible with vinylidene fluoride can be halogenated (fluorinated, chlorinated or brominated) or non-halogenated. Said monomer M1 may be selected from the group consisting of vinyl fluoride; trifluoroethylene (VF3); chlorotrifluoroethylene (CTFE); 1,2-difluoroethylene; tetrafluoroethylene (TFE); hexafluoropropylene (HFP); perfluoro(alkyl vinyl) ethers such as perfluoro(methyl vinyl) ether (PMVE), perfluoro(ethyl vinyl) ether (PEVE) and perfluoro(propyl vinyl) ether (PPVE); perfluoro(1,3-dioxole); perfluoro(2,2-dimethyl-1,3-dioxole) (PDD); the monomer of formula CF₂═CFOCF₂CF(CF₃)OCF₂CF₂X in which X is SO₂F, CO₂H, CH₂OH, CH₂OCN or CH₂OPO₃H; the monomer of formula CF₂═CFOCF₂CF₂SO₂F; the monomer of formula F(CF₂)nCH₂OCF═CF₂ in which n is 1, 2, 3, 4 or 5; the monomer of formula R¹CH₂OCF═CF₂ in which R¹ is hydrogen or F(CF₂)m and m is 1, 2, 3 or 4; the monomer of formula R²OCF═CH₂ in which R² is F(CF₂)p and p is 1, 2, 3 or 4; perfluorobutyl ethylene (PFBE); trifluoropropene, tetrafluoropropene, hexafluoroisobutylene, perfluorobutylethylene, pentafluoropropene, bromotrifluoroethylene, chlorofluoroethylene, chlorotrifluoropropene and 2-trifluoromethyl-3,3,3-trifluoro-1-propene, or a mixture thereof. Among the trifluoropropenes, mention may be made of 3,3,3-trifluoropropene. Mention may be made, among the tetrafluoropropenes, of 2,3,3,3-tetrafluoropropene or 1,3,3,3-tetrafluoropropene. Mention may be made, among the pentafluoropropenes, of 1,1,3,3,3-pentafluoropropene or 1,2,3,3,3-pentafluoropropene. Chlorofluoroethylene can denote either 1-chloro-1-fluoroethylene or 1-chloro-2-fluoroethylene. The 1-chloro-1-fluoroethylene isomer is preferred. The chlorotrifluoropropene is preferably 1-chloro-3,3,3-trifluoropropene or 2-chloro-3,3,3-trifluoropropene.

Advantageously, said monomer M1 may be selected from the group consisting of vinyl fluoride, trifluoroethylene, chlorotrifluoroethylene, 1,2-difluoroethylene, tetrafluoroethylene, hexafluoropropylene, perfluoro(alkyl vinyl) ethers such as perfluoro(methyl vinyl) ether (PMVE), perfluoro(ethyl vinyl) ether (PEVE), and perfluoro(propyl vinyl) ether (PPVE); perfluoro(1,3-dioxole); perfluoro(2,2-dimethyl-1,3-dioxole) (PDD), perfluorobutyl ethylene (PFBE), trifluoropropene, tetrafluoropropene, hexafluoroisobutylene, perfluorobutyl ethylene, pentafluoropropene, bromotrifluoroethylene, chlorofluoroethylene, chlorotrifluoropropene, and 2-trifluoromethyl-3,3,3-trifluoro-1-propene, or a mixture thereof.

Preferably, said monomer M1 may be selected from the group consisting of vinyl fluoride, trifluoroethylene, chlorotrifluoroethylene, 1,2-difluoroethylene, tetrafluoroethylene, hexafluoropropylene, perfluoro(alkyl vinyl) ethers such as perfluoro(methyl vinyl) ether (PMVE), perfluoro(ethyl vinyl) ether (PEVE), and perfluoro(propyl vinyl) ether (PPVE); perfluorobutyl ethylene (PFBE), trifluoropropene, tetrafluoropropene, hexafluoroisobutylene, perfluorobutyl ethylene, pentafluoropropene, bromotrifluoroethylene, chlorofluoroethylene, and chlorotrifluoropropene, or a mixture thereof.

More preferentially, said monomer M1 may be selected from the group consisting of vinyl fluoride, trifluoroethylene, chlorotrifluoroethylene, 1,2-difluoroethylene, tetrafluoroethylene, hexafluoropropylene, perfluoro(methyl vinyl) ether, perfluoro(ethyl vinyl) ether, perfluoro(propyl vinyl) ether, perfluorobutyl ethylene, trifluoropropene, tetrafluoropropene, hexafluoroisobutylene, perfluorobutyl ethylene, pentafluoropropene, bromotrifluoroethylene, chlorofluoroethylene, and chlorotrifluoropropene, or a mixture thereof.

In particular, said monomer M1 may be selected from the group consisting of vinyl fluoride, trifluoroethylene, chlorotrifluoroethylene, 1,2-difluoroethylene, tetrafluoroethylene, and hexafluoropropylene, or a mixture thereof.

According to one embodiment, in said polymer P1, the mass content of vinylidene fluoride units is preferably at least 50%, preferably at least 60%, more preferably greater than 70%, and particularly greater than 80% based on the total weight of said polymer P1. Thus, the mass content of said monomer M1 in said polymer P1 is less than 50%, advantageously less than 40%, preferably less than 30%, more preferentially less than 20% based on the total weight of said polymer P1. According to a preferred embodiment, the mass content of said monomer M1 in said polymer P1 is between 0.5% and 20%, advantageously between 0.5% and 19%, preferably between 0.5% and 18%, more preferentially between 0.5% and 17%, in particular between 0.5% and 16%, more particularly between 0.5% and 15% based on the total weight of said polymer P1. The mass content of said monomer M1 in said polymer P1 may also be between 1% and 20%, advantageously between 1% and 19%, preferably between 1% and 18%, more preferentially between 1% and 17%, in particular between 1% and 16%, more particularly between 1% and 15% based on the total weight of said polymer P1. The mass content of said monomer M1 in said polymer P1 may also be between 2% and 20%, advantageously between 2% and 19%, preferably between 2% and 18%, more preferentially between 2% and 17%, in particular between 2% and 16%, more particularly between 2% and 15% based on the total weight of said polymer P1.

According to a preferred embodiment, said polymer P1 is a copolymer comprising monomer units derived from vinylidene fluoride and monomer units derived from hexafluoropropylene; preferably, the mass content of the monomer units derived from vinylidene fluoride is at least 50%, preferably at least 60%, more preferably at least 70% and advantageously at least 80% based on the total weight of said polymer P1. More particularly, said polymer P1 is a copolymer comprising monomer units resulting from vinylidene fluoride and monomer units resulting from hexafluoropropylene; the mass content of the vinylidene fluoride units is greater than 65% and the mass content of the hexafluoropropylene units is less than 35%. Preferably, the polymer P1 is a copolymer comprising monomer units resulting from vinylidene fluoride and monomer units resulting from hexafluoropropylene; the mass content of the vinylidene fluoride units is greater than 85% and the mass content of the hexafluoropropylene units is less than 15%.

According to a particular embodiment, polymer P1 is a copolymer comprising monomer units derived from vinylidene fluoride and monomer units derived from hexafluoropropylene; the mass content of hexafluoropropylene is between 0.5% and 20%, advantageously between 0.5% and 19%, preferably between 0.5% and 18%, more preferentially between 0.5% and 17%, in particular between 0.5% and 16%, and more particularly between 0.5% and 15% based on the total weight of said polymer P1. Advantageously, polymer P1 is a copolymer comprising monomer units derived from vinylidene fluoride and monomer units derived from hexafluoropropylene; the mass content of hexafluoropropylene is between 1% and 20%, advantageously between 1% and 19%, preferably between 1% and 18%, more preferentially between 1% and 17%, in particular between 1% and 16%, more particularly between 1% and 15% based on the total weight of said polymer P1. Preferably, polymer P1 is a copolymer comprising monomer units derived from vinylidene fluoride and monomer units derived from hexafluoropropylene; the mass content of hexafluoropropylene is between 2% and 20%, advantageously between 2% and 19%, preferably between 2% and 18%, more preferentially between 2% and 17%, in particular between 2% and 16%, more particularly between 2% and 15% based on the total weight of said polymer P1. In particular, in this embodiment, the mass content of vinylidene fluoride units is preferably at least 50%, preferably at least 60%, more preferably greater than 70%, and particularly greater than 80% based on the total weight of said polymer P1.

When said polymer P1 has a mass content of vinylidene fluoride units of at least 50%, preferably at least 60%, more preferably greater than 70% and particularly greater than 80%, it may also comprise said monomer M2 in a mass content of from 0.05% by weight to 10% by weight based on the total weight of said polymer P1 and optionally comprises said monomer M1 according to any one of the embodiments detailed above. Preferably, in this embodiment, said monomer M2 is present in a mass content of from 0.05% by weight to 5% by weight, in particular from 0.05% to 2% based on the total weight of said polymer P1.

When said polymer P1 comprises at least 50% by weight of said monomer M2, it may also comprise monomer units derived from a monomer M3. Said monomer M3 may be
(A) an alkenyl compound containing a functional group, or
(B) an alkenyl compound without a functional group.

The alkenyl compound (A) containing a functional group comprises, for example, α,β-unsaturated carboxylic acids such as acrylic acid, methacrylic acid, fumaric acid, crotonic acid, itaconic acid and the like; vinyl ester compounds such as vinyl acetate, vinyl neodecanoate and the like; amide compounds such as acrylamide, methacrylamide, N-methylacrylamide, N-methylmethacrylamide, N-methylolacrylamide, N-methylolmethacrylamide, N-alkylacrylamide, N-alkylmethacrylamide, N,N-dialkylacrylamide, N,N-dialkylmethacrylamide, diacetone acrylamide and the like; acrylic acid esters such as 2-hydroxyethyl acrylate, N-dialkylaminoethyl acrylate, glycidyl acrylate, n-dodecyl acrylate, fluoroalkyl acrylate and the like; and methacrylic acid esters such as dialkylaminoethyl methacrylate, fluoroalkyl methacrylate, 2-hydroxyethyl methacrylate, n-octyl methacrylate, t-butyl methacrylate, glycidyl methacrylate, ethylene glycol dimethacrylate and the like; maleic anhydride, and alkenyl glycidyl ether compounds such as allyl glycidyl ether and the like. Among these, preference is given to acrylic acid, methacrylic acid, itaconic acid, fumaric acid, N-methylolacrylamide, N-methylolmethacrylamide, diacetone acrylamide, 2-hydroxyethyl acrylate, 2-hydroxyethyl methacrylate and allyl glycidyl ether. These compounds may be used alone or as a mixture of two or more. The alkenyl compound without a functional group (B) comprises, for example, conjugated dienes, such as 1,3-butadiene, isoprene and the like; divinyl hydrocarbon compounds, such as divinylbenzene and the like; and alkenyl cyanides, such as acrylonitrile, methacrylonitrile and the like. Among these, the preferred compounds are 1,3-butadiene and acrylonitrile. These compounds may be used alone or as a mixture of two or more. It is preferred that the functional alkenyl compound (A) be used in a proportion of less than 50% by weight relative to the weight of polymer P1 and that the alkenyl compound without a functional group (B) be used in a proportion of less than 30% by weight relative to the weight of polymer P1. As mentioned above, said polymer P1 has a particular particle size distribution. This makes it possible to achieve the desired properties and to have a good compromise between adhesion and ion conductivity. Thus, said polymer P1 has a Dv99 particle size distribution of less than 89 μm. The Dv99 is the particle size at the 99th percentile (by volume) of the cumulative particle size distribution. This parameter can be determined by laser particle size analysis. This applies to all the Dv99 values described in the present description. This particle size distribution is measured using a particle size analyzer, and the measurement is performed by the dry method by laser diffraction on the powder. Advantageously, said polymer P1 has a particle size distribution Dv99 of less than or equal to 85 μm, preferably less than or equal to 80 μm, more preferentially less than or equal to 75 μm, in particular less than or equal to 70 μm, more particularly less than or equal to 65 μm, preferably less than or equal to 60 μm, advantageously preferably less than or equal to 55 μm, preferentially preferably less than or equal to 50 μm, and particularly preferably less than or equal to 45 μm. Said polymer P1 may have a particle size distribution Dv99 greater than or equal to 5 μm, preferably greater than or equal to 7 μm, more preferentially greater than or equal to 9 μm, in particular greater than or equal to 11 μm, more particularly greater than or equal to 13 μm, preferably greater than or equal to 15 μm, advantageously preferably greater than or equal to 17 μm, preferentially preferably greater than or equal to 19 μm, particularly preferably greater than or equal to 20 μm, and more particularly preferably greater than or equal to 24 μm.

Thus, according to a particular embodiment, said polymer P1 has a particle size distribution Dv99 of less than or equal to 89 μm, advantageously less than or equal to 85 μm, preferably less than or equal to 80 μm, more preferentially less than or equal to 75 μm, in particular less than or equal to 70 μm, more particularly less than or equal to 65 μm, preferably less than or equal to 60 μm, advantageously preferably less than or equal to 55 μm, preferentially preferably less than or equal to 50 μm, and particularly preferably less than or equal to 45 μm; and said polymer P1 has a particle size distribution Dv99 of greater than or equal to 5 μm, preferably greater than or equal to 7 μm, more preferentially greater than or equal to 9 μm, in particular greater than or equal to 11 μm, more particularly greater than or equal to 13 μm, preferably greater than or equal to 15 μm, advantageously preferably greater than or equal to 17 μm, preferentially preferably greater than or equal to 19 μm, particularly preferably greater than or equal to 20 μm, more particularly preferably greater than or equal to 24 μm.

Said polymer P1 may also have a particle size distribution Dv10 of greater than or equal to 2.0 μm. The Dv10 is the particle size at the 10th percentile (by volume) of the cumulative particle size distribution. This parameter may be determined by laser granulometry as mentioned above. This particle size distribution is also measured using a particle size analyzer, and the measurement is performed by the dry method by laser diffraction on the powder. This applies to all the Dv10 values described in the present description. Said polymer P1 may have a particle size distribution Dv10 of greater than or equal to 2.1 μm, advantageously greater than or equal to 2.2 μm, preferably greater than or equal to 2.3 μm, more preferentially greater than or equal to 2.4 μm, in particular greater than or equal to 2.5 μm, more particularly greater than or equal to 2.6 μm, preferably greater than or equal to 2.7 μm, advantageously preferably greater than or equal to 2.8 μm, preferentially preferably greater than or equal to 2.9 μm, and more preferentially preferably greater than or equal to 3.0 μm. However, it has been noted that when said polymer P1 had a particle size distribution Dv10 of less than 2.9, this penalized the ion conductivity. Specifically, the pores of the separator support and the pores between the particles of said polymer P1 tend to become clogged. It is thus preferred to favor a particle size distribution Dv10 of greater than or equal to 3.0 μm.

Said polymer P1 may have a particle size distribution Dv10 of greater than or equal to 3.1 μm, advantageously greater than or equal to 3.2 μm, preferably greater than or equal to 3.3 μm, more preferentially greater than or equal to 3.4 μm, in particular greater than or equal to 3.5 μm, more particularly greater than or equal to 3.6 μm, preferably greater than or equal to 3.7 μm, advantageously preferably greater than or equal to 3.8 μm, preferentially greater than or equal to 3.9 μm, and more preferentially greater than or equal to 4.0 μm. Said polymer P1 may have a particle size distribution Dv10 of less than or equal to 12 μm, advantageously less than or equal to 11 μm, preferably less than or equal to 10 μm, more preferentially less than or equal to 9 μm, in particular less than or equal to 8 μm, more particularly less than or equal to 7 μm.

Thus, according to a particular embodiment, said polymer P1 has a particle size distribution Dv10 of greater than or equal to 2.0 μm, advantageously greater than or equal to 2.1 μm, preferably greater than or equal to 2.2 μm, more preferentially greater than or equal to 2.3 μm, in particular greater than or equal to 2.4 μm, more particularly greater than or equal to 2.5 μm, preferably greater than or equal to 2.6 μm, advantageously preferably greater than or equal to 2.7 μm, preferentially preferably greater than or equal to 2.8 μm, more preferentially preferably greater than or equal to 2.9 μm, particularly preferably greater than or equal to 3.0 μm; and said polymer P1 has a particle size distribution Dv10 of less than or equal to 12 μm, advantageously less than or equal to 11 μm, preferably less than or equal to 10 μm, more preferentially less than or equal to 9 μm, in particular less than or equal to 8 μm, more particularly less than or equal to 7 μm.

Thus, according to a particular embodiment, said polymer P1 has a particle size distribution Dv10 of greater than or equal to 3.1 μm, advantageously greater than or equal to 3.2 μm, preferably greater than or equal to 3.3 μm, more preferentially greater than or equal to 3.4 μm, in particular greater than or equal to 3.5 μm, more particularly greater than or equal to 3.6 μm, preferably greater than or equal to 3.7 μm, advantageously preferably greater than or equal to 3.8 μm, preferentially greater than or equal to 3.9 μm, and more preferentially greater than or equal to 4.0 μm; and said polymer P1 has a particle size distribution Dv10 of less than or equal to 12 μm, advantageously less than or equal to 11 μm, preferably less than or equal to 10 μm, more preferentially less than or equal to 9 μm, in particular less than or equal to 8 μm, more particularly less than or equal to 7 μm.

Said polymer P1 may also have a particle size distribution Dv90 of less than 50 μm. The Dv90 is the particle size at the 90th percentile (by volume) of the cumulative particle size distribution. This parameter may be determined by laser granulometry as mentioned above. This particle size distribution is also measured using a particle size analyzer, and the measurement is performed by the dry method by laser diffraction on the powder. This applies to all the Dv90 values described in the present description. Advantageously, said polymer P1 has a particle size distribution Dv90 of less than or equal to 48 μm, preferably less than or equal to 46 μm, more preferentially less than or equal to 44 μm, in particular less than or equal to 42 μm, more particularly less than or equal to 40 μm, preferably less than or equal to 38 μm, advantageously preferably less than or equal to 36 μm, preferentially preferably less than or equal to 34 μm, particularly preferably less than or equal to 32 μm, and more particularly preferably less than or equal to 30 μm. Said polymer P1 may have a particle size distribution Dv90 of greater than or equal to 1 μm, advantageously greater than or equal to 2 μm, preferably greater than or equal to 3 μm, more preferentially greater than or equal to 4 μm, in particular greater than or equal to 5 μm, more particularly greater than or equal to 6 μm, preferably greater than or equal to 7 μm, advantageously preferably greater than or equal to 8 μm, preferentially preferably greater than or equal to 9 μm, and particularly preferably greater than or equal to 10 μm.

Thus, according to a particular embodiment, said polymer P1 has a particle size distribution Dv90 of less than or equal to 50 μm, advantageously less than or equal to 48 μm, preferably less than or equal to 46 μm, more preferentially less than or equal to 44 μm, in particular less than or equal to 42 μm, more particularly less than or equal to 40 μm, preferably less than or equal to 38 μm, advantageously preferably less than or equal to 36 μm, preferentially preferably less than or equal to 34 μm, particularly preferably less than or equal to 32 μm, and more particularly preferably less than or equal to 30 μm; and said polymer P1 has a particle size distribution Dv90 of greater than or equal to 1 μm, advantageously greater than or equal to 2 μm, preferably greater than or equal to 3 μm, more preferentially greater than or equal to 4 μm, in particular greater than or equal to 5 μm, more particularly greater than or equal to 6 μm, preferably greater than or equal to 7 μm, advantageously preferably greater than or equal to 8 μm, preferentially preferably greater than or equal to 9 μm, particularly preferably greater than or equal to 10 μm.

According to a preferred embodiment, said polymer P1 is a has a particle size distribution:
Dv99 of less than or equal to 89 μm, advantageously less than or equal to 85 μm, preferably less than or equal to 80 μm, more preferentially less than or equal to 75 μm, in particular less than or equal to 70 μm, more particularly less than or equal to 65 μm, preferably less than or equal to 60 μm, advantageously preferably less than or equal to 55 μm, preferentially preferably less than or equal to 50 μm, and particularly preferably less than or equal to 45 μm;
Dv10 of greater than or equal to 2.0 μm, advantageously greater than or equal to 2.1 μm, preferably greater than or equal to 2.2 μm, more preferentially greater than or equal to 2.3 μm, in particular greater than or equal to 2.4 μm, more particularly greater than or equal to 2.5 μm, preferably greater than or equal to 2.6 μm, advantageously preferably greater than or equal to 2.7 μm, preferentially preferably greater than or equal to 2.8 μm, more preferentially preferably greater than or equal to 2.9 μm, and particularly preferably greater than or equal to 3.0 μm; or Dv10 of greater than or equal to 3.1 μm, advantageously greater than or equal to 3.2 μm, preferably greater than or equal to 3.3 μm, more preferentially greater than or equal to 3.4 μm, in particular greater than or equal to 3.5 μm, more particularly greater than or equal to 3.6 μm, preferably greater than or equal to 3.7 μm, advantageously preferably greater than or equal to 3.8 μm, preferentially greater than or equal to 3.9 μm, more preferentially greater than or equal to 4.0 μm; and
Dv90 of less than or equal to 50 μm, advantageously less than or equal to 48 μm, preferably less than or equal to 46 μm, more preferentially less than or equal to 44 μm, in particular less than or equal to 42 μm, more particularly less than or equal to 40 μm, preferably less than or equal to 38 μm, advantageously preferably less than or equal to 36 μm, preferentially preferably less than or equal to 34 μm, particularly preferably less than or equal to 32 μm, and more particularly preferably less than or equal to 30 μm.

According to another preferred embodiment, said polymer P1 is a has a particle size distribution:
Dv99 of less than or equal to 89 μm, advantageously less than or equal to 85 μm, preferably less than or equal to 80 μm, more preferentially less than or equal to 75 μm, in particular less than or equal to 70 μm, more particularly less than or equal to 65 μm, preferably less than or equal to 60 μm, advantageously preferably less than or equal to 55 μm, preferentially preferably less than or equal to 50 μm, and particularly preferably less than or equal to 45 μm; and greater than or equal to 5 μm, preferably greater than or equal to 7 μm, more preferentially greater than or equal to 9 μm, in particular greater than or equal to 11 μm, more particularly greater than or equal to 13 μm, preferably greater than or equal to 15 μm, advantageously preferably greater than or equal to 17 μm, preferentially preferably greater than or equal to 19 μm, particularly preferably greater than or equal to 20 μm, more particularly preferably greater than or equal to 24 μm;
Dv10 of greater than or equal to 2.0 μm, advantageously greater than or equal to 2.1 μm, preferably greater than or equal to 2.2 μm, more preferentially greater than or equal to 2.3 μm, in particular greater than or equal to 2.4 μm, more particularly greater than or equal to 2.5 μm, preferably greater than or equal to 2.6 μm, advantageously preferably greater than or equal to 2.7 μm, preferentially preferably greater than or equal to 2.8 μm, more preferentially preferably greater than or equal to 2.9 μm, and particularly preferably greater than or equal to 3.0 μm; or Dv10 of greater than or equal to 3.1 μm, advantageously greater than or equal to 3.2 μm, preferably greater than or equal to 3.3 μm, more preferentially greater than or equal to 3.4 μm, in particular greater than or equal to 3.5 μm, more particularly greater than or equal to 3.6 μm, preferably greater than or equal to 3.7 μm, advantageously preferably greater than or equal to 3.8 μm, preferentially greater than or equal to 3.9 μm, more preferentially greater than or equal to 4.0 μm; and less than or equal to 12 μm, advantageously less than or equal to 11 μm, preferably less than or equal to 10 μm, more preferentially less than or equal to 9 μm, in particular less than or equal to 8 μm, more particularly less than or equal to 7 μm;
Dv90 of less than or equal to 50 μm, advantageously less than or equal to 48 μm, preferably less than or equal to 46 μm, more preferentially less than or equal to 44 μm, in particular less than or equal to 42 μm, more particularly less than or equal to 40 μm, preferably less than or equal to 38 μm, advantageously preferably less than or equal to 36 μm, preferentially preferably less than or equal to 34 μm, particularly preferably less than or equal to 32 μm, and more particularly preferably less than or equal to 30 μm; and greater than or equal to 1 μm, advantageously greater than or equal to 2 μm, preferably greater than or equal to 3 μm, more preferentially greater than or equal to 4 μm, in particular greater than or equal to 5 μm, more particularly greater than or equal to 6 μm, preferably greater than or equal to 7 μm, advantageously preferably greater than or equal to 8 μm, preferentially preferably greater than or equal to 9 μm, particularly preferably greater than or equal to 10 μm.

Said polymer P1 may have a melt viscosity greater than or equal to 10 kP at 230° C. and at a shear rate of 100 s⁻¹ measured according to the standard ASTM D3835, advantageously greater than or equal to 12 kP, preferably greater than or equal to 14 kP, in particular greater than or equal to 15 kP at 230° C. and at a shear rate of 100 s⁻¹ measured according to the standard ASTM D3835. Preferably, when the polymer P1 comprises monomer units M0, at least 50% by weight based on the total weight thereof, and optionally M1, the melt viscosity of said polymer P1 is greater than or equal to 10 kP at 230° C. and at a shear rate of 100 s⁻¹ measured according to the standard ASTM D3835; advantageously, the melt viscosity of said polymer P1 is greater than or equal to 12 kP, preferably greater than or equal to 14 kP, more preferentially greater than or equal to 15 kP at 230° C. and at a shear rate of 100 s⁻¹ measured according to the standard ASTM D3835. Preferably, when polymer P1 comprises monomer units derived from vinylidene fluoride and monomer units derived from hexafluoropropene M1, the melt viscosity of said polymer P1 is greater than or equal to 10 kP at 230° C. and at a shear rate of 100 s⁻¹ measured according to the standard ASTM D3835; advantageously, the melt viscosity of said polymer P1 is greater than or equal to 12 kP, preferably greater than or equal to 14 kP, more preferentially greater than or equal to 15 kP at 230° C. and at a shear rate of 100 s⁻¹ measured according to the standard ASTM D3835.

According to a preferred embodiment, when the polymer P1 comprises monomer units M0, at least 50% by weight based on the total weight thereof, and optionally M1, the melt viscosity of said polymer P1 is greater than or equal to 40 kP at 230° C. and at a shear rate of 100 s⁻¹ measured according to the standard ASTM D3835. Advantageously, the melt viscosity of said polymer P1 is greater than or equal to 45 kP, preferably greater than or equal to 50 kP, more preferentially greater than or equal to 55 kP, in particular greater than or equal to 60 kP at 230° C. and at a shear rate of 100 s⁻¹ measured according to the standard ASTM D3835. According to a particular embodiment, when polymer P1 comprises monomer units M0, at least 50% by weight based on the total weight thereof, and optionally M1, polymer P1 comprises a functional group that improves adhesion to metal. Thus, said polymer P1 may comprise monomer units bearing at least one of the functions selected from the group consisting of carboxylic acid, carboxylic acid anhydride, carboxylic acid esters, epoxy groups such as glycidyl, amide, hydroxyl, carbonyl, mercapto, sulfide, oxazoline, phenolic, ester, ether, siloxane, sulfonic, sulfuric, phosphoric and phosphonic; preferably carboxylic acid, carboxylic acid anhydride, carboxylic acid esters, hydroxyl, phosphoric and phosphonic; in particular at least one carboxylic acid, carboxylic acid anhydride, carboxylic acid ester function. The functional group may be introduced via a chemical reaction, which may be grafting or copolymerization with a monomer bearing at least one of said functional groups and a vinyl function that is capable of copolymerizing with vinylidene fluoride or monomer M1, according to techniques well known to those skilled in the art. The functionality may be introduced via the transfer agent used in the process for synthesizing said polymer P1. The transfer agent may be a polymer with a molar mass of less than or equal to 20 000 g/mol and which bears functional groups chosen from the following groups: carboxylic acid, carboxylic acid anhydride, carboxylic acid esters, epoxy (such as glycidyl), amide, hydroxyl, carbonyl, mercapto, sulfide, oxazoline, phenolic, ester, ether, siloxane, sulfonic, sulfuric, phosphoric or phosphonic. Acrylic acid oligomers are an example of transfer agent of this type. According to a preferred embodiment, the transfer agent is an acrylic acid oligomer with a molar mass of less than or equal to 20 000 g/mol. Alternatively, the functional group may be introduced by an oligomeric or polymeric compound comprising said functional group and mixed with polymer P1. The oligomeric or polymeric compound may be impregnated into or mixed with polymer P1 or intimately mixed therewith. In this case, the functional group may be derived from a (meth)acrylic acid compound chosen from acrylic acid, methacrylic acid, hydroxyethyl (meth)acrylate, hydroxypropyl (meth)acrylate, hydroxyethylhexyl (meth)acrylate and acryloyloxy propyl succinate. For example, the functional group may be an oligomer or polymer comprising monomer units derived from a monomer selected from the group consisting of acrylic acid, methacrylic acid, hydroxyethyl (meth)acrylate, hydroxypropyl (meth)acrylate, hydroxyethylhexyl (meth)acrylate and acryloyloxy propyl succinate. According to one embodiment, said oligomer or polymer has a weight-average molecular mass of less than or equal to 100 000 g/mol, advantageously less than 80 000 g/mol, preferably less than 60 000 g/mol, more preferentially less than 40 000 g/mol, in particular less than 20 000 g/mol. The weight-average molecular mass is determined by GPC by using a Waters 2695e apparatus coupled with a Wyatt NEON refractometer equipped with two PL Gel mixed C columns and a guard column (7.8 mm I.D.×30 cm, 5 μm) under the following conditions: temperature: 35° C.; flow rate: 1.0 mL/min; injection volume: 100 μL. The samples are prepared to a concentration of 1 mg/mL in THF. Twelve samples of poly(methyl methacrylate) with a molecular mass of 535 to 2 210 000 g/mol are used as calibration standards. When it contains a functional group as mentioned above, the content thereof in said polymer P1 is at least 0.01 mol %, preferably at least 0.1 mol %, and not more than 15 mol %, preferably not more than 10 mol %.

According to a particular embodiment, when said polymer P1 comprises monomer units derived from a monomer M2, at least 50% by weight based on the total weight thereof, said polymer P1 has a pH of between 1.5 and 4.0, advantageously between 1.6 and 3.9, preferably between 1.7 and 3.8, more preferentially between 1.8 and 3.7, in particular between 1.9 and 3.6, and more particularly between 2.0 and 3.5, measured in water at room temperature. A pH meter of the Mettler Toledo SevenEasy brand or equivalent and an InLab Routine Pro electrode are used to measure the pH. Before the calibrating, the state of cleanliness of the electrode is ascertained. If necessary, the electrode is cleaned with warm soapy water. It is ascertained that the pH electrode is always kept filled with KCl filling solution. The device is calibrated with buffer solutions of pH 10, 7 and 4. In order to calibrate, the electrode is dipped in the pH 10 buffer solution and pressed on CaI; once the pH has stabilized, the operation is repeated with the pH 7 and then pH 4 buffer. The electrode is rinsed with distilled water and dried between each buffer. The electrode is prepared beforehand before the measurement by dipping in a 0.1M HCl solution for one to two hours and then rinsed with deionized water. In order to measure the pH, the electrode is dipped in the product as is to be tested and is stirred for a few seconds. The measurement is left to stabilize for 15 min and the value displayed by the pH meter is read. The measurement is performed at room temperature.

Preferably, when said polymer P1 comprises monomer units derived from a monomer M2, at least 50% by weight based on the total weight thereof, said polymer P1 has a glass transition temperature of less than or equal to 230° C. Advantageously, said polymer P1 has a glass transition temperature of less than or equal to 220° C., preferably less than 200° C., more preferentially less than 180° C., in particular less than 160° C., more particularly less than or equal to 150° C. The glass transition temperatures indicated herein are calculated using the Fox equation. The Fox equation is an equation used to predict the glass transition temperature of random copolymers:

1/Tg,copo≈Σiωi/Tg,i
where Tg,copo is the glass transition temperature of the copolymer,
Tg,i are those of the homopolymers i corresponding to each comonomer,
ωi are the mass fractions of the monomers i constituting this copolymer.

The mass fractions are expressed without units. The glass transition temperatures are expressed in degrees Kelvin. The temperature is subsequently converted into degrees Celsius.

As mentioned above, said polymer P1 is free of fluoro surfactants. Said polymer P1 may comprise between 10 ppm and 2% by weight of a surfactant comprising polyethylene glycol or polypropylene glycol units. Preferably, said surfactant has an HLB value of from 1 to 20, in particular an HLB value of from 1 to 5 or from 10 to 15. In particular, said surfactant comprises a polyethylene glycol segment and a polypropylene glycol segment, and has an HLB value of from 1 to 5 and a weight-average molecular mass of from 5000 to 10 000 g·mol⁻¹. Alternatively, said surfactant comprises a polyethylene glycol segment and a polypropylene glycol segment, and has an HLB value of from 10 to 15 and a weight-average molecular weight of from 500 to 2500 g·mol⁻¹.

### Composition

Preferably, said composition according to the present invention comprises at least 50%, advantageously at least 60%, preferably at least 70%, more preferentially at least 80%, in particular at least 90%, more particularly at least 95% by weight of said polymer P1 according to the present invention based on the total weight of said composition.

According to a particular embodiment, when polymer P1 comprises monomer units M0, at least 50% by weight based on the total weight thereof, and optionally M1, said composition may optionally comprise a polymer P2 comprising monomer units derived from a monomer selected from the group consisting of acrylic acid, methyl acrylate, ethyl acrylate, propyl acrylate, n-butyl acrylate, isobutyl acrylate, t-butyl acrylate, n-dodecyl acrylate, amyl acrylate, isoamyl acrylate, hexyl acrylate, 2-ethylhexyl acrylate, diacetoneacrylamide, lauryl acrylate, n-octyl acrylate, hydroxypropyl methacrylate, hydroxybutyl acrylate, methyl acrylic acid, methyl acrylate, methyl methacrylate, ethyl methacrylate, propyl methacrylate, n-butyl methacrylate, isobutyl methacrylate, t-butyl methacrylate, n-dodecyl methacrylate, amyl methacrylate, isoamyl methacrylate, hexyl methacrylate, 2-ethylhexyl methacrylate, lauryl methacrylate, n-octyl methacrylate, and ureido methacrylate.

According to a particular embodiment, when polymer P1 comprises monomer units M2, at least 50% by weight based on the total weight thereof, said composition may optionally comprise a polymer P3 comprising monomer units comprising monomer units derived from a monomer selected from the group consisting of vinylidene fluoride or a monomer M1 as defined in the present patent application or a mixture thereof. Said polymer P1 may be obtained by an emulsion or suspension polymerization process according to usual techniques known to those skilled in the art. Polymer P1 is generally obtained in the form of a latex, dispersion, or aqueous solution. The composition according to the present invention may be obtained from a latex comprising said polymer P1 via a drying step followed by a step to achieve the desired size distribution. The drying step may be performed by atomization or co-atomization, preferably at a temperature of 100° C. to 220° C., or freeze-drying. The powder may also be obtained by grinding techniques, for instance, cryogenic grinding, in which the mixture is brought to a temperature below room temperature, for example, by means of liquid nitrogen, prior to grinding. At the end of the powder manufacturing step, i.e. after the drying step, the particle size may be adjusted and optimized by selection or screening processes and/or by grinding, granulation, screening, compaction, or shearing. One or more of these techniques may be used to achieve the desired size distribution.

When the composition comprises, in addition to polymer P1, said polymer P2 or said polymer P3, said polymers may be mixed in powder form, or in the form of an aqueous dispersion followed by drying. Said polymer P1 may also form an interpenetrating polymer network (IPN or semi-IPN) with said polymer P2 or said polymer P3.

Preferably, said polymer P2 and said polymer P3 have a size distribution in the same range as that of said polymer P1. Thus, said polymer P2 or said polymer P3 has a particle size distribution Dv99 of less than 89 μm. The Dv99 is the particle size at the 99th percentile (by volume) of the cumulative particle size distribution. This parameter can be determined by laser particle size analysis. This applies to all the Dv99 values described in the present description. This particle size distribution is measured using a particle size analyzer, and the measurement is performed by the dry method by laser diffraction on the powder. Advantageously, said polymer P2 or said polymer P3 has a particle size distribution Dv99 of less than or equal to 85 μm, preferably less than or equal to 80 μm, more preferentially less than or equal to 75 μm, in particular less than or equal to 70 μm, more particularly less than or equal to 65 μm, preferably less than or equal to 60 μm, advantageously preferably less than or equal to 55 μm, preferentially preferably less than or equal to 50 μm, and particularly preferably less than or equal to 45 m.

Said polymer P2 or said polymer P3 may have a particle size distribution Dv99 greater than or equal to 5 μm, preferably greater than or equal to 7 μm, more preferentially greater than or equal to 9 μm, in particular greater than or equal to 11 μm, more particularly greater than or equal to 13 μm, preferably greater than or equal to 15 μm, advantageously preferably greater than or equal to 17 μm, preferentially preferably greater than or equal to 19 μm, particularly preferably greater than or equal to 20 μm, and more particularly preferably greater than or equal to 24 μm.

Thus, according to a particular embodiment, said polymer P2 or said polymer P3 has a particle size distribution Dv99 of less than or equal to 89 μm, advantageously less than or equal to 85 μm, preferably less than or equal to 80 μm, more preferentially less than or equal to 75 μm, in particular less than or equal to 70 μm, more particularly less than or equal to 65 μm, preferably less than or equal to 60 μm, advantageously preferably less than or equal to 55 μm, preferentially preferably less than or equal to 50 μm, and particularly preferably less than or equal to 45 μm; and said polymer P2 or said polymer P3 has a particle size distribution Dv99 of greater than or equal to 5 μm, preferably greater than or equal to 7 μm, more preferentially greater than or equal to 9 μm, in particular greater than or equal to 11 μm, more particularly greater than or equal to 13 μm, preferably greater than or equal to 15 μm, advantageously preferably greater than or equal to 17 μm, preferentially preferably greater than or equal to 19 μm, particularly preferably greater than or equal to 20 μm, more particularly preferably greater than or equal to 24 μm.

Said polymer P2 or said polymer P3 may also have a particle size distribution Dv10 of greater than or equal to 2.0 μm. The Dv10 is the particle size at the 10th percentile (by volume) of the cumulative particle size distribution. This parameter may be determined by laser granulometry as mentioned above. This particle size distribution is also measured using a particle size analyzer, and the measurement is performed by the dry method by laser diffraction on the powder. This applies to all the Dv10 values described in the present description. Said polymer P2 or said polymer P3 may have a particle size distribution Dv10 of greater than or equal to 2.1 μm, advantageously greater than or equal to 2.2 μm, preferably greater than or equal to 2.3 μm, more preferentially greater than or equal to 2.4 μm, in particular greater than or equal to 2.5 μm, more particularly greater than or equal to 2.6 μm, preferably greater than or equal to 2.7 μm, advantageously preferably greater than or equal to 2.8 μm, preferentially preferably greater than or equal to 2.9 μm, and more preferentially preferably greater than or equal to 3.0 μm.

Said polymer P2 or said polymer P3 may have a particle size distribution Dv10 of greater than or equal to 3.1 μm, advantageously greater than or equal to 3.2 μm, preferably greater than or equal to 3.3 μm, more preferentially greater than or equal to 3.4 μm, in particular greater than or equal to 3.5 μm, more particularly greater than or equal to 3.6 μm, preferably greater than or equal to 3.7 μm, advantageously preferably greater than or equal to 3.8 μm, preferentially greater than or equal to 3.9 μm, and more preferentially greater than or equal to 4.0 μm. Said polymer P2 or said polymer P3 may have a particle size distribution Dv10 of less than or equal to 12 μm, advantageously less than or equal to 11 μm, preferably less than or equal to 10 μm, more preferentially less than or equal to 9 μm, in particular less than or equal to 8 μm, more particularly less than or equal to 7 μm.

Thus, according to a particular embodiment, said polymer P2 or said polymer P3 has a particle size distribution Dv10 of greater than or equal to 2.0 μm, advantageously greater than or equal to 2.1 μm, preferably greater than or equal to 2.2 μm, more preferentially greater than or equal to 2.3 μm, in particular greater than or equal to 2.4 μm, more particularly greater than or equal to 2.5 μm, preferably greater than or equal to 2.6 μm, advantageously preferably greater than or equal to 2.7 μm, preferentially preferably greater than or equal to 2.8 μm, more preferentially preferably greater than or equal to 2.9 μm, particularly preferably greater than or equal to 3.0 μm; and said polymer P2 or said polymer P3 has a particle size distribution Dv10 of less than or equal to 12 μm, advantageously less than or equal to 11 μm, preferably less than or equal to 10 μm, more preferentially less than or equal to 9 μm, in particular less than or equal to 8 μm, more particularly less than or equal to 7 μm.

Thus, according to a particular embodiment, said polymer P2 or said polymer P3 has a particle size distribution Dv10 of greater than or equal to 3.1 μm, advantageously greater than or equal to 3.2 μm, preferably greater than or equal to 3.3 μm, more preferentially greater than or equal to 3.4 μm, in particular greater than or equal to 3.5 μm, more particularly greater than or equal to 3.6 μm, preferably greater than or equal to 3.7 μm, advantageously preferably greater than or equal to 3.8 μm, preferentially greater than or equal to 3.9 μm, and more preferentially greater than or equal to 4.0 μm; and said polymer P2 or said polymer P3 has a particle size distribution Dv10 of less than or equal to 12 μm, advantageously less than or equal to 11 μm, preferably less than or equal to 10 μm, more preferentially less than or equal to 9 μm, in particular less than or equal to 8 μm, more particularly less than or equal to 7 μm.

Said polymer P2 or said polymer P3 may also have a particle size distribution Dv90 of less than or equal to 50 μm. The Dv90 is the particle size at the 90th percentile (by volume) of the cumulative particle size distribution. This parameter may be determined by laser granulometry as mentioned above. This particle size distribution is also measured using a particle size analyzer, and the measurement is performed by the dry method by laser diffraction on the powder. This applies to all the Dv90 values described in the present description. Advantageously, said polymer P2 or said polymer P3 has a particle size distribution Dv90 of less than or equal to 48 μm, preferably less than or equal to 46 μm, more preferentially less than or equal to 44 μm, in particular less than or equal to 42 μm, more particularly less than or equal to 40 μm, preferably less than or equal to 38 μm, advantageously preferably less than or equal to 36 μm, preferentially preferably less than or equal to 34 μm, particularly preferably less than or equal to 32 μm, and more particularly preferably less than or equal to 30 μm. Said polymer P2 or said polymer P3 may have a particle size distribution Dv90 of greater than or equal to 1 μm, advantageously greater than or equal to 2 μm, preferably greater than or equal to 3 μm, more preferentially greater than or equal to 4 μm, in particular greater than or equal to 5 μm, more particularly greater than or equal to 6 μm, preferably greater than or equal to 7 μm, advantageously preferably greater than or equal to 8 μm, preferentially preferably greater than or equal to 9 μm, and particularly preferably greater than or equal to 10 μm.

Thus, according to a particular embodiment, said polymer P2 or said polymer P3 has a particle size distribution Dv90 of less than or equal to 50 μm, advantageously less than or equal to 48 μm, preferably less than or equal to 46 μm, more preferentially less than or equal to 44 μm, in particular less than or equal to 42 μm, more particularly less than or equal to 40 μm, preferably less than or equal to 38 μm, advantageously preferably less than or equal to 36 μm, preferentially preferably less than or equal to 34 μm, particularly preferably less than or equal to 32 μm, and more particularly preferably less than or equal to 30 μm; and said polymer P2 or said polymer P3 has a particle size distribution Dv90 of greater than or equal to 1 μm, advantageously greater than or equal to 2 μm, preferably greater than or equal to 3 μm, more preferentially greater than or equal to 4 μm, in particular greater than or equal to 5 μm, more particularly greater than or equal to 6 μm, preferably greater than or equal to 7 μm, advantageously preferably greater than or equal to 8 μm, preferentially preferably greater than or equal to 9 μm, particularly preferably greater than or equal to 10 μm.

According to a preferred embodiment, said polymer P2 or said polymer P3 is a has a particle size distribution:
Dv99 of less than or equal to 89 μm, advantageously less than or equal to 85 μm, preferably less than or equal to 80 μm, more preferentially less than or equal to 75 μm, in particular less than or equal to 70 μm, more particularly less than or equal to 65 μm, preferably less than or equal to 60 μm, advantageously preferably less than or equal to 55 μm, preferentially preferably less than or equal to 50 μm, and particularly preferably less than or equal to 45 μm;
Dv10 of greater than or equal to 2.0 μm, advantageously greater than or equal to 2.1 μm, preferably greater than or equal to 2.2 μm, more preferentially greater than or equal to 2.3 μm, in particular greater than or equal to 2.4 μm, more particularly greater than or equal to 2.5 μm, preferably greater than or equal to 2.6 μm, advantageously preferably greater than or equal to 2.7 μm, preferentially preferably greater than or equal to 2.8 μm, more preferentially preferably greater than or equal to 2.9 μm, and particularly preferably greater than or equal to 3.0 μm; or Dv10 of greater than or equal to 3.1 μm, advantageously greater than or equal to 3.2 μm, preferably greater than or equal to 3.3 μm, more preferentially greater than or equal to 3.4 μm, in particular greater than or equal to 3.5 μm, more particularly greater than or equal to 3.6 μm, preferably greater than or equal to 3.7 μm, advantageously preferably greater than or equal to 3.8 μm, preferentially greater than or equal to 3.9 μm, more preferentially greater than or equal to 4.0 μm; and
Dv90 of less than or equal to 50 μm, advantageously less than or equal to 48 μm, preferably less than or equal to 46 μm, more preferentially less than or equal to 44 μm, in particular less than or equal to 42 μm, more particularly less than or equal to 40 μm, preferably less than or equal to 38 μm, advantageously preferably less than or equal to 36 μm, preferentially preferably less than or equal to 34 μm, particularly preferably less than or equal to 32 μm, and more particularly preferably less than or equal to 30 μm.

According to another preferred embodiment, said polymer P2 or said polymer P3 is a has a particle size distribution:
Dv99 of less than or equal to 89 μm, advantageously less than or equal to 85 μm, preferably less than or equal to 80 μm, more preferentially less than or equal to 75 μm, in particular less than or equal to 70 μm, more particularly less than or equal to 65 μm, preferably less than or equal to 60 μm, advantageously preferably less than or equal to 55 μm, preferentially preferably less than or equal to 50 μm, and particularly preferably less than or equal to 45 μm; and greater than or equal to 5 μm, preferably greater than or equal to 7 μm, more preferentially greater than or equal to 9 μm, in particular greater than or equal to 11 μm, more particularly greater than or equal to 13 μm, preferably greater than or equal to 15 μm, advantageously preferably greater than or equal to 17 μm, preferentially preferably greater than or equal to 19 μm, particularly preferably greater than or equal to 20 μm, more particularly preferably greater than or equal to 24 μm;
Dv10 of greater than or equal to 2.0 μm, advantageously greater than or equal to 2.1 μm, preferably greater than or equal to 2.2 μm, more preferentially greater than or equal to 2.3 μm, in particular greater than or equal to 2.4 μm, more particularly greater than or equal to 2.5 μm, preferably greater than or equal to 2.6 μm, advantageously preferably greater than or equal to 2.7 μm, preferentially preferably greater than or equal to 2.8 μm, more preferentially preferably greater than or equal to 2.9 μm, and particularly preferably greater than or equal to 3.0 μm; or Dv10 of greater than or equal to 3.1 μm, advantageously greater than or equal to 3.2 μm, preferably greater than or equal to 3.3 μm, more preferentially greater than or equal to 3.4 μm, in particular greater than or equal to 3.5 μm, more particularly greater than or equal to 3.6 μm, preferably greater than or equal to 3.7 μm, advantageously preferably greater than or equal to 3.8 μm, preferentially greater than or equal to 3.9 μm, more preferentially greater than or equal to 4.0 μm; and less than or equal to 12 μm, advantageously less than or equal to 11 μm, preferably less than or equal to 10 μm, more preferentially less than or equal to 9 μm, in particular less than or equal to 8 μm, more particularly less than or equal to 7 μm;
Dv90 of less than or equal to 50 μm, advantageously less than or equal to 48 μm, preferably less than or equal to 46 μm, more preferentially less than or equal to 44 μm, in particular less than or equal to 42 μm, more particularly less than or equal to 40 μm, preferably less than or equal to 38 μm, advantageously preferably less than or equal to 36 μm, preferentially preferably less than or equal to 34 μm, particularly preferably less than or equal to 32 μm, and more particularly preferably less than or equal to 30 μm; and greater than or equal to 1 μm, advantageously greater than or equal to 2 μm, preferably greater than or equal to 3 μm, more preferentially greater than or equal to 4 μm, in particular greater than or equal to 5 μm, more particularly greater than or equal to 6 μm, preferably greater than or equal to 7 μm, advantageously preferably greater than or equal to 8 μm, preferentially preferably greater than or equal to 9 μm, particularly preferably greater than or equal to 10 μm.

### Separator

Said composition according to the present invention may be used as one of the materials for the preparation of a separator in an electrochemical device. Said composition is preferably used in the separator coating. In addition to said composition, the separator coating may contain inorganic particles which serve to form micropores in the coating (the interstices between inorganic particles). The addition of inorganic particles can also contribute to the heat resistance or improve the wettability. According to one embodiment, said coating comprises from 50% to 99% by weight of inorganic particles, relative to the weight of the coating. These inorganic particles must be electrochemically stable (not subject to oxidation and/or to reduction within the range of voltages which are used). In addition, the pulverulent inorganic materials preferably have a high ion conductivity. Low-density materials are preferred to materials of higher density, since the weight of the battery produced can be reduced. The dielectric constant is preferably equal to or greater than 5. According to one embodiment, said inorganic particles are selected from the group consisting of: BaTiO₃, Pb(Zr,Ti)O₃, Pb₁₋ₓLaₓZr_{y}O₃ (0<x<1, 0<y<1), PbMg₃Nb_{2/3})₃, PbTiO₃, hafnia (HfO(HfO₂)), SrTiO₃, SnO₂, CeO₂, MgO, NiO, CaO, ZnO, Y₂O₃, boehmite (y-AlO(OH)), Al₂O₃, TiO₂, SiC, ZrO₂, boron silicate, BaSO4, nanoclays or mixtures thereof. In this case, the ratio of the solids of polymer P1, and optionally P2 and P3, to the inorganic particles is from 0.5 to 40 parts by weight of solids of the total composition per 60 to 99.5 parts by weight of inorganic particles. Advantageously, the ratio of the solids of polymer P1, and optionally P2 and P3, to the inorganic particles is from 0.5 to 35 per 65 to 99.5 parts by weight of inorganic particles. Preferably, the ratio of the solids of polymer P1, and optionally P2 and P3, to the inorganic particles is from 0.5 to 30 per 70 to 99.5 parts by weight of inorganic particles. The separator coating may optionally comprise from 0% to 15% by weight, on the basis of the polymer, and preferably from 0.1% to 10% by weight of additives chosen from thickeners, pH-adjusting agents, anti-settling agents, surfactants, wetting agents, fillers, anti-foaming agents and fugitive or non-fugitive adhesion promoters. The fillers mentioned here in the additives are different from the inorganic particles mentioned above.

Said separator according to the present invention comprises a coating as described above, optionally arranged on one or both faces of a porous support. In this case, the coating is used to coat the support of the separator, on at least one face, in the form of a monolayer or of multilayers. There is no specific limitation on the choice of the support which is coated with the coating of the invention, as long as it is a porous substrate having pores. Said support may comprise a single layer or several distinct layers. When it comprises several layers, the coating as described in the present invention is arranged on the external face of the support, that is to say on the face which will be first in contact with the electrolyte composition used in the battery. Advantageously, the application of the coating to the support takes place by the aqueous route or by the solvent route. The porous substrate may be in the form of a membrane or a fibrous fabric. When the porous substrate is fibrous, it may be a nonwoven web forming a porous web, such as a web obtained by direct spinning or melt blowing (of spun bond or melt blown type) or electrospinning. Examples of porous substrates that are useful in the invention as support comprise, without being limited thereto: polyolefins, polyethylene terephthalate, polybutylene terephthalate, polyester, polyacetal, polyamide, polycarbonate, polyimide, polyether ether ketone, polyether sulfone, poly(phenylene oxide), poly(phenylene sulfide), polyethylene naphthalate or mixtures thereof. However, other engineering plastics which are heat-resistant may be used, without specific limitation. Nonwoven materials made of natural and synthetic materials may also be used as substrate of the separator. The porous substrate generally has a thickness of 1 to 50 μm, and is typically membranes obtained by extrusion and drawing (wet or dry processes) or cast nonwovens. The porous substrate preferably has a porosity of between 5% and 95%. The average size of the pores (diameter) is preferably of between 0.001 and 50 μm, more preferably between 0.01 and 10 μm.

According to another embodiment, said separator comprises a porous support as described above on which a first layer of inorganic particles as defined in the present patent application is deposited. On said first layer, a second layer comprising said composition according to the present invention is deposited.

According to an alternative embodiment, said separator does not comprise a porous support. In this case, said separator consists of the coating as described above and comprising said composition; it is deposited directly on the cathode or on the anode of the electrochemical device. The absence of a porous support allows the production costs of the electrochemical device and its dimensions to be limited. In this case, said coating replaces the porous support. In this embodiment, said composition preferably has a porosity of from 5% to 95%. The separator coating of the invention has an excellent compromise of properties for separator coating application: good dry and wet adhesion, good resistance to electrolyte solvent(s) characterized by good conserved integrity and moderate swelling.

### Electrode

Said composition may also be used as an electrode binder, preferably for a cathode. The electrode comprises said composition of the present invention, a conductive agent, and an active material.

In a preferred embodiment, the electrode has the following mass composition:
a. 50% to 99.9% of active material, preferably 50% to 99%,
b. 25% to 0% of conductive agent, preferably 25% to 0.5%,
c. 25% to 0.05% of said composition according to the invention, preferably 25% to 0.5%,
d. 0% to 5% of at least one additive chosen from the group consisting of a plasticizer, an ionic liquid, a dispersing agent for conductive additive, and a flow aid agent; the sum of all these percentages being 100%.

The conductive agents in the electrode are composed of one or more materials which can improve the conductivity. Some examples comprise carbon blacks, such as acetylene black or Ketjen black: carbon fibers, such as a carbon nanotube, a carbon nanofiber or a vapor grown carbon fiber; or metal powders, such as an SUS powder and an aluminum powder.

The active materials are materials which are capable of storing and releasing lithium ions.

In a preferred embodiment, said electrode is a negative electrode. In particular, for a negative electrode, said active material is chosen from the group consisting of a lithium alloy, a metal oxide, a carbon material, such as graphite or hard carbon, silicon, a silicon alloy and Li₄Ti₅O₁₂. The form of the negative electrode active material is not particularly limited but is preferably particulate.

In another preferred embodiment, said electrode is a positive electrode. Preferably, for a cathode, said active material is chosen from the group consisting of LiCoO₂, Li(Ni, Co, Al)O₂, Li₍₁₊ₓ₎, NiₐMn_{b}Co_{c} (x represents a real number of 0 or more, a=0.8, 0.6, 0.5 or ⅓, b=0.1, 0.2, 0.3 or ⅓, c=0.1, 0.2 or ⅓), LiNiO₂, LiMn₂O₄, LiCoMnO₄, Li₃NiMn₃O₃, Li₃Fe₂(PO₄)₃, Li₃V₂(PO₄)₃, an Li Mn spinel substituted by a different element having a composition represented by Li₁₊ₓMn_{2-x-y}M_{y}O₄, M representing at least one metal chosen from Al, Mg, Co, Fe, Ni and Zn, x and y independently representing a real number of between 0 and 2, lithium titanate LiₓTiO_{y}, x and y independently representing a real number of between 0 and 2, and a lithium metal phosphate having a composition represented by LiMPO₄, M representing Fe, Mn, Co or Ni. Furthermore, the surface of each of the materials described above can be coated. The coating material is not particularly limited as long as it has a conductivity for lithium ions and contains a material capable of being maintained in the form of a coating layer on the surface of the active material. Examples of coating materials comprise LiNbO₃, Li₄Ti₅O₁₂, and Li₃PO₄. The form of the cathode active material is not particularly limited but is preferably particulate.

Said electrode may be prepared via a process with or without solvent, said process comprising the following steps:
mixing the active filler, said composition according to the invention, conductive filler, and any additives by means of a process that produces an electrode formulation that can be applied to a metal substrate via a process without solvent or in the presence of a solvent;
deposition of said electrode formulation on the metal substrate via a process without solvent or in the presence of a solvent to obtain an Li-ion battery electrode,
optionally, a solvent evaporation step; and
consolidating said electrode by a heat treatment (application of a temperature ranging up to 50° C. above the melting temperature of the polymer, without mechanical pressure) and/or thermomechanical treatment such as calendering or thermocompression.

The term “solvent-free” process means a process in which there is no need for a step of evaporation of residual solvent downstream of the deposition step.

When a solvent is used, it may be water or an organic solvent, in particular a polar organic solvent with a dipole moment greater than 1.5 Debye. As organic solvents, mention may be made of, in a nonlimiting manner, of N-methylpyrrolidone, dimethylformamide, dimethylacetamide, N,N-dimethylaminopropylamine, tetrahydrofuran, dimethyl sulfoxide, acetone, methyl ethyl ketone, cyclohexanone, gamma-butyrolactone and gamma-valerolactone.

As process for solvent-free mixing of the various constituents of the electrode formulation, mention may be made, without this being an exhaustive list, of: mixing by agitation, air-jet mixing, high-shear mixing, mixing with a V-mixer, mixing with a screw mixer, double-cone mixing, drum mixing, conical mixing, double Z-arm mixing, mixing in a fluidized bed, mixing in a planetary mixer, mixing by mechanofusion, mixing by extrusion, mixing by calendering, mixing by milling.

Other mixing processes that may be mentioned include mixing options using a liquid such as water, for example spray drying (co-atomization or co-spraying) or a process of spraying a liquid containing the binder and/or the conductive filler onto a fluidized powder bed of the active filler.

The metal supports of the electrodes are generally made of aluminum for the cathode and of copper for the anode. The metal supports can be surface-treated and have a conductive primer with a thickness of 5 μm or more. The supports can also be woven or non-woven fabrics made of carbon fiber. The consolidation of said electrode is effected by a heat treatment, by passage through an oven, under an infrared lamp, through a calender with heated rollers or through a press with heated plates. Another alternative consists of a two-step process. First of all, the electrode is subjected to a heat treatment in an oven, under an infrared lamp or by contact with heated plates without pressure. A step of compression at ambient or elevated temperature is then performed by means of a calender or a plate press. This step makes it possible to adjust the porosity of the electrode and to improve adhesion to the metal substrate.

### EXAMPLES

Three polymer samples A1, A2, and A3 were tested. The three polymers A1, A2, and A3 are copolymers of vinylidene fluoride with hexafluoropropylene, comprising a carboxylic acid functional group and having a melt viscosity of 74.25 kP measured at 230° C. and a shear rate of 100 s⁻¹ measured according to the standard ASTM D3835. In all three cases, the hexafluoropropylene content is 4.5% by weight. Two other samples according to the invention were prepared, A4 and A5. Sample A4 is a copolymer of vinylidene fluoride with 10% hexafluoropropylene having a melt viscosity of 16.0 kP measured at 230° C. and a shear rate of 100 s⁻¹ measured according to the standard ASTM D3835. Sample A5 is a copolymer of vinylidene fluoride with 6.1% by weight of hexafluoropropylene, having a melt viscosity of 49.1 kP measured at 230° C. and a shear rate of 100 s⁻¹ measured according to the standard ASTM D3835.

The size distribution of the three samples is shown in Table 1 below.

TABLE 1

| | Dv99 | Dv90 | Dv10 |
|---|---|---|---|
| A1 (invention) | 25.5 μm | 12.8 μm | 3.1 μm |
| A2 (invention) | 39.7 μm | 23.5 μm | 4.6 μm |
| A4 (invention) | 41.8 μm | 17.8 μm | 5.2 μm |
| A5 (invention) | 22.4 μm | 13.4 μm | 5.8 μm |
| A3 (comparative) | 90.0 μm | 50.2 μm | 9.2 μm |

From these three samples in powder form, separator coatings were prepared according to the protocol below. For each coating, the adhesion and the Gurley value were measured and reported as a function of the copolymer loading used to prepare the separators. In the tests performed with sample A1, the loading was 1.2 g/m². In the tests performed with sample A2, the loading was 1.6 g/m². In tests performed with sample A3, the loading was 2.8 g/m².

### Preparation of Redispersed Powder Compositions

The samples in powder form (100 g) and the dispersant (BYK-21486, 2 g) are added to a CMC solution (Nippon Paper F04HC, 4.5 g in 900 g of deionized water), and the powder is then dispersed and, optionally, deagglomerated using a Filmix mixer operated at 10 m/s and 20° C. for 1 h. A binder (BYK-LPC-22346, 6 g) and a wetting agent (BYK-LPX-20990, 1.8 g) are then added to the dispersion, which is then homogenized with a magnetic stirrer at 1000 rpm for 20 min.

### Measurement of the Particle Size Distribution

The specific particle diameters D10, D90, and D99 represent the volume-mean values of the diameter at 10%, 90%, and 99% respectively of the cumulative volume in the particle size distribution, measured with Microtrac S3500 Bluewave and using water as the dispersion medium. The analysis may be performed directly on the redispersed powder compositions. To analyze the powder, the following protocol is followed: 0.5 g of powder is placed in a 100 mL jar with 2 mL of surfactant (10% Triton X-100) and 60 mL of demineralized water. The mixture is stirred with a magnetic stir bar for 10 min at 200 rpm, and then for 5 min in an ultrasonic tank. The mixture is analyzed with a Microtrac S3500 Bluewave particle size analyzer in wet mode.

### Separator Coating

This formulation is then applied to a Celgard® C210 SP separator using a coating bar equipped with a 50 μm aperture doctor blade at a speed of 30 mm/s. The coated separator is dried at 60° C. for 5 minutes.

### Basis Weight

The basis weight of the deposited coating is determined using a precision balance by weighing discs 24 mm in diameter cut out with a punch, by the difference between the coated separator and the bare separator.

### Dry Adhesion

Two separator samples are assembled with their coated faces in contact using a roller press operated at 90° C., 1.5 MPa, 2.4 m/min. From this assembly, a 22.5 cm strip is cut, one face of which is then bonded to an aluminum plate (3×10 cm) with double-sided tape. At one end of the sample, the double layer of separators is peeled off by hand over a distance of about 5 mm. The sample is installed in the 180° tensile test with this part of the separator peeled off in one of the jaws and the aluminum plate in the other jaw. The peel strength is measured at 50 mm/min, and then reported to the sample width and normalized by the coating basis weight.

### Gurley Measurement

The Gurley permeability (Gurley 4110N densitometer with 4320EN auto-timer) of each coated separator is measured, and the permeability of the support (measured at 415 sec/100 cc) is then subtracted to obtain the Gurley permeability value of the coating, which is then normalized by the coating basis weight.

The results are shown in Table 2 below.

TABLE 2

| | HFP | Adhesion/ | Gurley (sec/100 |
|---|---|---|---|
| | content (%) | loading | ml)/loading |
| A1 (invention) | 4.5 | 0.67 | 27.8 |
| A2 (invention) | 4.5 | 0.43 | 14.8 |
| A4 (invention) | 10 | 1.41 | 39.8 |
| A5 (invention) | 6.1 | 0.85 | 32.3 |
| A3 (comparative) | 4.5 | 0.25 | 2.96 |

As demonstrated by the above examples, the use of a composition according to the present invention provides improved adhesion while at the same time maintaining acceptable ion conductivity for the intended applications. The selection of a polymer having a particular size distribution as mentioned in claim 1 offers a significant advantage over a polymer whose size distribution is too high or too heterogeneous.

1. A composition, in powder form, comprising a polymer P1 comprising monomer units derived from a monomer M0 which is vinylidene fluoride or monomer units derived from a monomer M2 having the formula R1R2C═C(R3)C(O)R in which the substituents R1, R2 and R3 are, independently of each other, selected from the group consisting of H and C1-C5 alkyl; R is selected from the group consisting of —NHC(CH3)2CH2C(O)CH3 or —OR′ with R′ selected from the group consisting of H and C1-C18 alkyl optionally substituted with one or more —OH groups or a five- or six-membered heterocycle comprising at least one nitrogen atom in its ring chain; or a mixture of said monomer units M0 or M2; characterized in that said polymer P1 has a particle size distribution Dv99 less than or equal to 89 μm and a particle size distribution Dv10 greater than or equal to 2.0 μm.

2. The composition of claim 1, characterized in that said polymer P1 is a homopolymer of vinylidene fluoride or a copolymer comprising monomer units derived from vinylidene fluoride and monomer units derived from a monomer M1, wherein M1 is selected from the group consisting of vinyl fluoride, tetrafluoroethylene, hexafluoropropylene, trifluoropropenes, tetrafluoropropenes, hexafluoroisobutylene, perfluorobutylethylene, pentafluoropropenes, perfluoroalkylvinyl ethers, bromotrifluoroethylene, chlorofluoroethylene, chlorotrifluoroethylene, and chlorotrifluoropropene, or a mixture thereof; or a copolymer comprising monomer units derived from vinylidene fluoride and monomer units derived from monomer M2.

3. The composition of claim 2, characterized in that said monomer M1 is hexafluoropropylene.

4. The composition of claim 2, characterized in that the mass content of said monomer M1 in said polymer P1 is between 0.5% and 20% based on the total weight of said polymer P1, or the mass content of said monomer M2 in said polymer P1 is between 0.01% and 10% based on the total weight of said polymer P1.

5. The composition of claim 2, characterized in that the melt viscosity of said polymer P1 is greater than or equal to 10 kP at 230° C. and at a shear rate of 100 s-1 measured according to the standard ASTM D3835.

6. The composition of claim 2, characterized in that said polymer P1 also comprises a functional group selected from the group consisting of carboxylic acid, carboxylic acid anhydride, carboxylic acid esters, epoxy, amide, hydroxyl, carbonyl, mercapto, sulfide, oxazoline, phenolic, ester, ether, siloxane, sulfonic, sulfuric, phosphoric and phosphonic; preferably carboxylic acid, carboxylic acid anhydride, carboxylic acid esters, hydroxyl, phosphoric and phosphonic.

7. The composition of claim 2, characterized in that said polymer P1 has a particle size distribution Dv99 of less than or equal to 89 μm and a particle size distribution Dv10 of greater than or equal to 2.9 μm.

8. The composition of claim 1, characterized in that said polymer P1 contains monomer units derived from a monomer M2, wherein M2 is selected from the group consisting of acrylic acid, methyl acrylate, ethyl acrylate, propyl acrylate, n-butyl acrylate, isobutyl acrylate, t-butyl acrylate, n-dodecyl acrylate, amyl acrylate, isoamyl acrylate, hexyl acrylate, 2-ethylhexyl acrylate, diacetone acrylamide, lauryl acrylate, n-octyl acrylate, hydroxypropyl methacrylate, hydroxybutyl acrylate, methyl acrylic acid, methyl methacrylate, ethyl methacrylate, propyl methacrylate, n-butyl methacrylate, isobutyl methacrylate, t-butyl methacrylate, n-dodecyl methacrylate, amyl methacrylate, isoamyl methacrylate, hexyl methacrylate, 2-ethylhexyl methacrylate, lauryl methacrylate, n-octyl methacrylate, ureido methacrylate and mixtures thereof.

9. The composition of claim 1, characterized in that said polymer P1 has a particle size distribution Dv90 of less than or equal to 50 μm.

10. The composition of claim 1, characterized in that said polymer P1 is free of fluoro surfactants.

11. A separator comprising the composition of claim 1.

12. The separator of claim 11, characterized in that said separator comprises a porous support and the composition of claim 1; the composition being deposited onto one of the faces of the porous support.

13. An Li-ion secondary battery comprising an anode, a cathode and the separator of claim 11.

14. A binder for an Li-ion battery comprising the composition of claim 1.

15. An electrode for a lithium-ion battery including a metal collector, at least one face of which is covered with a layer of substrate containing an active substance and the binder of claim 14.

16. An Li-ion secondary battery comprising an anode, a cathode and a separator, wherein the anode or the cathode is the electrode of claim 15.
